(19) United States
(12) Patent Application Publication
(10) Pub. No.: US 2024/0391251 A1
(43) Pub. Date: Nov. 28, 2024

(54) TEXTILE PRINTING APPARATUS AND METHOD FOR PRODUCING TEXTILE PRINTED MATERIAL

(71) Applicant: RISO KAGAKU CORPORATION, Tokyo (JP)

(72) Inventors: Akiko HAYASHI, Tokyo (JP); Ryo SHINOTSUKA, Tokyo (JP)

(21) Appl. No.: 18/670,157

(22) Filed: May 21, 2024

(30) Foreign Application Priority Data
May 24, 2023 (JP) 2023-085122

(51) Int. Cl. B41J 3/407; B41M 5/00; D06P 5/00; D06P 5/30

(52) U.S. Cl. CPC B41J 3/4078; B41M 5/0017; D06P 5/002; D06P 5/30

(57) ABSTRACT

A textile printing apparatus includes a base forming ink head that discharges a base forming ink onto a base material to which a pretreatment liquid has been applied, a leveler that levels the base forming ink discharged on the base material, and an image forming ink head that discharges an image forming ink onto the base material on which the base forming ink has been leveled.

### CROSS-REFERENCE TO RELATED APPLICATION

This application is based upon and claims the benefit of priority of the prior Japanese Patent Application No. 2023-085122 filed on May 24, 2023, the entire contents of which are incorporated herein by reference.

### FIELD

Embodiments discussed herein are related to a textile printing apparatus that discharges a base forming ink and an image forming ink, and a method for producing a textile printed material.

### BACKGROUND

Conventionally, as a method for perform textile printing of an image such as a letter, a picture, or a pattern on a fabric such as a woven fabric, a knitted fabric, or a nonwoven fabric, there is an inkjet textile printing method in addition to a screen textile printing method and a roller textile printing method. Examples of an apparatus using the inkjet textile printing method include a textile printing apparatus that compresses a medium to be printed that is coated with a pretreatment liquid while heating the medium to be printed, and then discharges a printing liquid onto the medium to be printed (see, for example, JP 2015-183331 A).

### SUMMARY

In one aspect, a textile printing apparatus includes a base forming ink head that discharges a base forming ink onto a base material to which a pretreatment liquid has been applied, a leveler that levels the base forming ink discharged on the base material, and an image forming ink head that discharges an image forming ink onto the base material on which the base forming ink has been leveled.

An object and advantages of the invention will be realized and attained by means of the elements and combinations particularly pointed out in the claims.

### BRIEF DESCRIPTION OF THE DRAWINGS

FIG. 1 is a control configuration diagram illustrating a textile printing apparatus according to an embodiment and a user terminal;

FIG. 2 is a right side view illustrating a printing unit and the like of the textile printing apparatus according to an embodiment;

FIGS. 3A to 3D are right side views for describing each step of a method for producing a textile printed material according to an embodiment;

FIG. 4 is a diagram illustrating each step of the method for producing a textile printed material according to an embodiment;

FIG. 5 is a right side view illustrating a printing unit and the like of a textile printing apparatus according to a first modification of an embodiment;

FIGS. 6A and 6B are right side views illustrating a printing unit and the like of a textile printing apparatus according to a second modification of an embodiment; and

FIG. 7 is a table showing Examples 1 to 3 and Comparative Example of an embodiment.

### DETAILED DESCRIPTION

In the inkjet textile printing method, a pretreatment liquid containing an ink aggregating component may be applied to a colored base material such as a colored fabric, a base may be formed by discharging a base forming ink such as a white ink, and a color ink may be discharged onto the base. In this case, the base has a role of sharpening a color image formed on the base by hiding the color of the base material.

When an image forming ink such as the color ink is discharged onto the base material as described above, since a discharge unit and the base material are not in contact with each other, the print quality is likely to be affected by the fluff of the base material. Specifically, when the base forming ink is discharged onto the base material by a wet-on-wet method without passing through a drying step after the application of the pretreatment liquid, an ink ball in which the pretreatment liquid and the base forming ink are mixed is formed on the fluff of the base material. When the image forming ink is subsequently discharged onto the base material, an ink ball in which the pretreatment liquid, the base forming ink, and the image forming ink are mixed is formed. This ink ball is often present near the tip of the fluff at a position higher than the base material surface (horizontal plane). Thus, when the base material is dried by heat press or the like after image formation, the fluff falls down, and the ink ball formed on the fluff is fixed to a coordinate shifted in a horizontal direction by the height from the base material surface from the coordinate originally supposed to be landed, and landing position shift occurs.

In addition, a dot-like stain due to the ink ball being crushed is formed at the place where the ink ball has landed. In the case of a dark color base material, the use amount of the base forming ink is usually larger than the use amount of the image forming ink, and thus a dot with the color of the base forming ink is formed in the image. Since a white ink is often used as the base forming ink, white dots are usually scattered in the image. The print quality deteriorates due to the dot-like stain and the above-described landing position shift.

Even when the base forming ink is discharged by a wet-on-dry method after the pretreatment liquid is dried, the fluff of the base material lying during drying of the pretreatment liquid is likely to rise again, particularly when the pretreatment liquid containing no fixing component such as a resin is used. Thus, the print quality may deteriorate due to the landing position shift and the dot-like stain also in the case of discharging the base forming ink by the wet-on-dry method as in the case of discharging the base forming ink by the wet-on-wet method.

Hereinafter, a textile printing apparatus and a method for producing a textile printed material according to an embodiment of the present invention will be described with reference to the drawings.

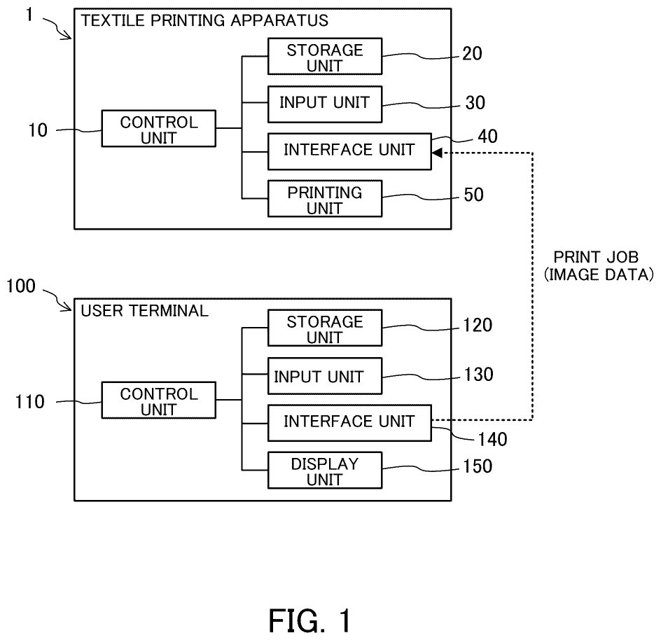

FIG. 1 is a control configuration diagram illustrating a textile printing apparatus 1 according to the present embodiment and a user terminal 100.

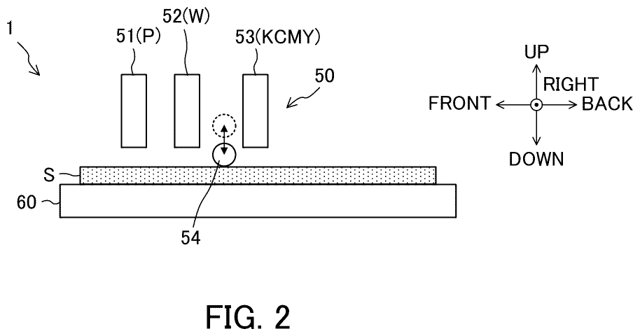

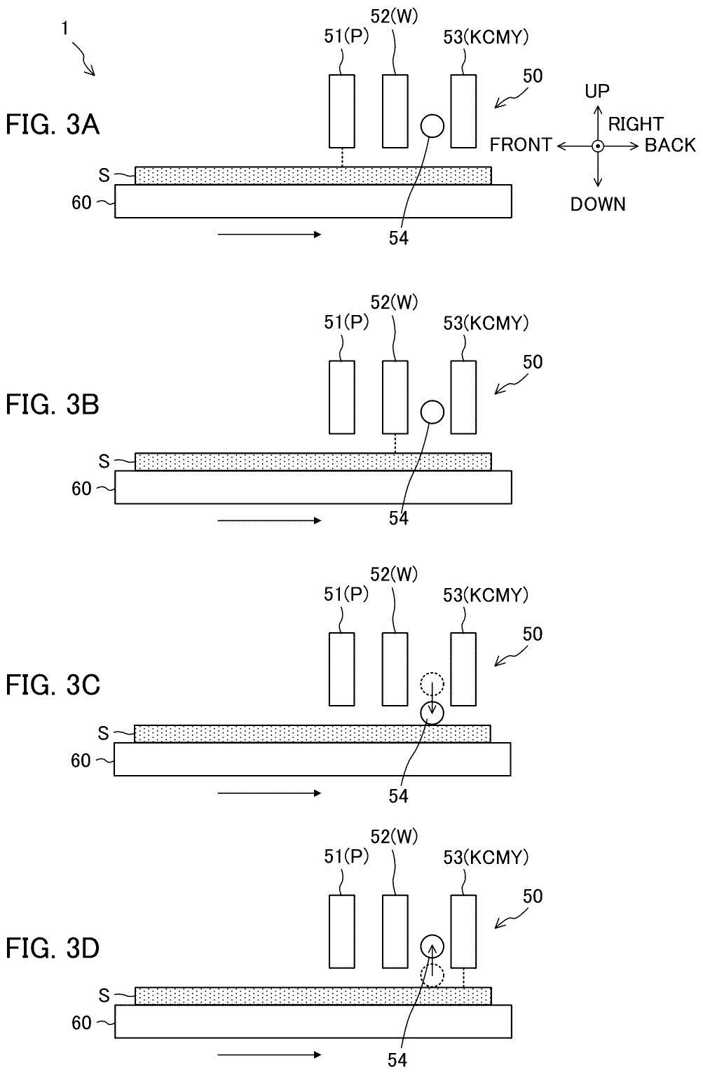

FIG. 2 is a right side view illustrating a printing unit 50 and the like of the textile printing apparatus 1. The front and back directions, left and right directions, and up and down directions in FIG. 2 and FIGS. 3A to 3D, 5, and 6A and 6B to be described later are examples in a case where the surface to be printed of a base material S is a horizontal plane, and the moving directions of the base material S (stage 60) are the front and back directions.

The textile printing apparatus 1 illustrated in FIG. 1 includes a control unit 10, a storage unit 20, an input unit 30, an interface unit 40, the printing unit 50, and a stage 60 (see FIG. 2). A system including a device such as the user terminal 100 that transmits a print job to the textile printing apparatus 1 (or a print control device that performs print control of the textile printing apparatus 1) and the textile printing apparatus 1 can be regarded as a print control system.

The control unit 10 includes one or more processors (for example, a central processing unit (CPU)) functioning as an arithmetic processing device that controls operation of each unit of the textile printing apparatus 1 such as the printing unit 50. This processor functions as, for example, a computer that reads out and executes a predetermined program from the storage unit 20 or from a storage medium (non-transitory computer-readable recording medium) that is detachably attached to the textile printing apparatus 1.

The storage unit 20 includes, for example, a memory, such as a read only memory (ROM) which is a read-only semiconductor memory in which a predetermined control program is recorded in advance, or a random access memory (RAM) which is a semiconductor memory used as a working storage area as necessary when the processor executes various control programs and is writable and readable at any time; and a hard disk device.

The input unit 30 is, for example, an operation panel that receives inputs of various types of information such as a print start operation and a position adjustment operation of the base material S.

The interface unit 40 exchanges various types of information with various devices such as the user terminal 100 connected wirelessly or by wire via a network, and receives, for example, a print job including image data from the user terminal 100.

As illustrated in FIG. 2, the printing unit 50 includes a plurality of heads 51 to 53 and a roller 54.

The head 51 (P) discharges the pretreatment liquid onto the base material S placed on the stage 60. Examples of the pretreatment liquid include a liquid containing an aggregating agent such as a polyvalent metal salt, an organic acid, a cationic polymer, or a cationic surfactant, which reacts with ink to aggregate the ink. The base material S is, for example, a fabric such as a woven fabric, a knitted fabric, or a nonwoven fabric.

The head 52 (W) is an example of a base forming ink discharge unit (base forming ink head) that discharges the base forming ink onto the base material S on which the pretreatment liquid has been discharged (applied). The base forming ink is, for example, a white ink. Here, printing with a light color ink such as a white ink as a base is performed to reduce the influence of the color of the base material S having a dark color such as black or dark blue on an image formed with a color ink. For example, when an image is formed on a black fabric using a color ink without a base, the image becomes blackish as compared with a case where the image is formed on a white fabric. In the embodiment for carrying out the invention in the present specification, a white ink will be described as the base forming ink.

The head 53 (KCMY) is an example of an image forming ink discharge unit (image forming ink head) that discharges the image forming ink. The image forming ink is, for example, an ink of each color of black, cyan, magenta, and yellow.

Here, each of the head 51 (P), the head 52 (W), and the head 53 (KCMY) takes a so-called serial method, and they discharge the pretreatment liquid or ink while moving in width directions (left and right directions) orthogonal to the moving directions (front and back directions) of the base material S. Since the base material S is placed on the stage 60, the base material S moves in the front and back directions along with the movement of the stage 60.

The roller 54 is disposed over the entire width directions (left and right directions) of the base material S in the printing region (printable region) of each of the heads 51 to 53. The roller 54 is disposed in a height-adjustable manner at a contact position (the position indicated by a solid line in FIG. 2) in contact with the base material S and a retracted position (the position indicated by a broken line in FIG. 2) retracted upward from the contact position. The roller 54 rotates in contact with the base material S at the contact position. This configuration causes the roller 54 to function as an example of a leveling unit (leveler) that levels the white ink discharged on the base material S from the head 52 (W). The roller 54 may be a driving roller connected to a driving source. A plurality of rollers 54 may be disposed in the moving directions of the base material S. The leveler may be a member such as a non-rotatable blade, or two or more types of levelers may be used. The user may level the white ink using an iron (non-heated state) having a flat leveling surface or a leveling unit such as a blade. When a blade is used, the blade may stand in a vertical direction or may be laid down in the vertical direction.

The user terminal 100 illustrated in FIG. 1 includes a control unit 110, a storage unit 120, an input unit 130, an interface unit 140, and a display unit 150. The user terminal 100 is, for example, a tablet device, a smartphone, a notebook computer, a desktop computer, or the like.

The control unit 110 includes, for example, one or more processors (for example, CPU) functioning as an arithmetic processing device that controls the operation of each unit of the control unit 110. The storage unit 120 includes, for example, a memory, such as a ROM which is a read-only semiconductor memory in which a predetermined control program is recorded in advance, or a RAM which is a semiconductor memory used as a working storage area as necessary when the processor executes various control programs and is writable and readable at any time; and a hard disk device. The input unit 130 is an operation key, a touch panel, or the like that receives inputs of various types of information. The interface unit 140 exchanges various information with various devices such as the textile printing apparatus 1 connected wirelessly or by wire via a network. The display unit 150 is a display that displays various types of information.

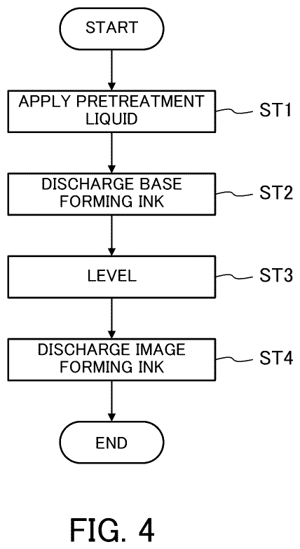

FIGS. 3A to 3D are right side views for describing each step of the method for producing a textile printed material according to the present embodiment. FIG. 4 is a diagram illustrating each step of the method for producing a textile printed material.

First, when the stage 60 is at an attaching/detaching position (not illustrated) of the base material S in front of the printing unit 50, the base material S is placed on the stage 60, and then, as illustrated in FIG. 3A, the head 51 (P) discharges the pretreatment liquid onto the base material S with the stage 60 (base material S) moving backward (step ST1 in FIG. 4).

The discharge amount of the pretreatment liquid is preferably 100 g/m² or less, more preferably 50 g/m² or less. Setting the discharge amount of the pretreatment liquid to 100 g/m² or less, in particular, 50 g/m² or less, can delay the progress of curing of a white ink to be described later that lands on the base material S. This makes it possible to perform the leveling step to be described later with the white ink having high flexibility, and thus the layer of the white ink can be leveled into a further flat layer.

On the other hand, the discharge amount of the pretreatment liquid is preferably 10 g/m² or more, more preferably 20 g/m² or more. Setting the application amount of the pretreatment liquid to 10 g/m² or more, in particular, 20 g/m² or more, causes the white ink that has landed on the base material S to be moderately thickened, and sufficient tackiness can be obtained. Thus, it is possible to prevent the fluff from rising again after the leveling step to be described later with respect to various base materials S such as the base material S with fluff that is likely to rise.

Next, after the stage 60 (base material S) has moved forward once, the head 52 (W) discharges the white ink onto the base material S as illustrated in FIG. 3B with the stage 60 (base material S) moving backward (step ST2 in FIG. 4). The discharge of the white ink may be performed only in a region where the image forming ink is to be discharged in an image forming ink discharge step (step ST4) to be described later, or may be performed in the entire printing region including this region.

The head 52 (W) may discharge the white ink in a state where a drying step is not performed after the pretreatment liquid is applied from the head 51 (P), that is, in a wet-on-wet manner. This causes the white ink to be thickened in a clay-like form by coming into contact with the pretreatment liquid, and an ink ball in which the ink and the pretreatment liquid are mixed is formed on the fluff of the base material S. Here, examples of the drying step include forced drying of the pretreatment liquid by heating the base material S and natural drying of the pretreatment liquid by leaving the base material S for several hours or more, for example. In the present embodiment, the white ink may be discharged by a wet-on-dry method in which such a drying step is performed.

The discharge amount of the white ink is preferably 50 g/m² or more, and more preferably 100 g/m² or more. When the discharge amount of the white ink is 50 g/m² or more, in particular, 100 g/m² or more, a base layer with reduced gaps between dots of the ink can be formed. Thus, the irregularities due to the gap can be reduced, and the layer of white ink can be leveled into a further flat layer in the leveling step to be described later.

In addition, the application amount of the white ink with respect to the application amount 1 of the pretreatment liquid on a mass basis is preferably 40 or less, and more preferably 20 or less. When the application amount of the base forming ink with respect to the application amount 1 of the pretreatment liquid is more than 40, the ink may adhere to the leveling unit depending on the type of the base material S. For example, when the roller 54 is used as the leveling unit, the white ink attached to the roller 54 may be retransferred to a place where the white ink is not supposed to be attached, which may deteriorate the print quality.

The white ink preferably contains a resin having a film elongation of 800% or more, and more preferably contains a resin having a film elongation of 1000% or more. For example, a white ink containing a water-dispersible resin (resin emulsion) having a film elongation of 800% or more, water, and a white pigment is preferable. A method for measuring the film elongation will be described later. When the white ink contains a resin having a film elongation of 800% or more, the white ink has high flexibility, and thus the white ink layer can be leveled into a further flat layer.

Next, after the stage 60 (base material S) has moved forward once, the roller 54 descends to the contact position indicated by the solid line in contact with the base material S as illustrated in FIG. 3C, and the roller 54 rotates and levels the white ink to a prescribed thickness as the stage 60 (base material S) moves backward (step ST3 in FIG. 4). This causes the fluff of the base material S and the ink ball attached to the fluff to be laid down. Since the white ink layer is a clay-like layer, the layer has strong tackiness, and the fluff that has been laid down at once is suppressed from rising again.

Leveling of the white ink may be performed within 10 minutes after the white ink is discharged. This makes it possible to level the white ink that has landed on the base material S in a state where dehydration and desolvation of the white ink have not proceeded, and thus the white ink can be leveled into a further flat layer in a highly flexible state. Leveling of the white ink may be performed in a state where the white ink is not heated. This makes it possible to suppress dehydration and desolvation of the white ink that has landed on the base material S, and thus the white ink can be leveled into a further flat layer in a highly flexible state.

Next, after the stage 60 (base material S) has moved forward once, the head 53 (KCMY) discharges inks of respective colors of black, cyan, magenta, and yellow onto the base material S as illustrated in FIG. 3D with the stage 60 (base material S) moving backward (step ST4 in FIG. 4). At the time of discharging the ink, the roller 54 is ascended to the retracted position indicated by the solid line.

In the examples of FIGS. 3A to 3D described above, discharging of the pretreatment liquid or ink with each of the heads 51 to 53 and leveling of the white ink are performed with the base material S moving backward, but the moving direction of the base material S at the time of discharging the pretreatment liquid or ink or leveling may be any direction. In the present embodiment, the stage 60 moves in the front and back directions, but each of the heads 51 to 53 and the roller 54 may move in the front and back directions. That is, the heads 51 to 53 and the rollers 54 and the base material S may relatively move in the front and back directions.

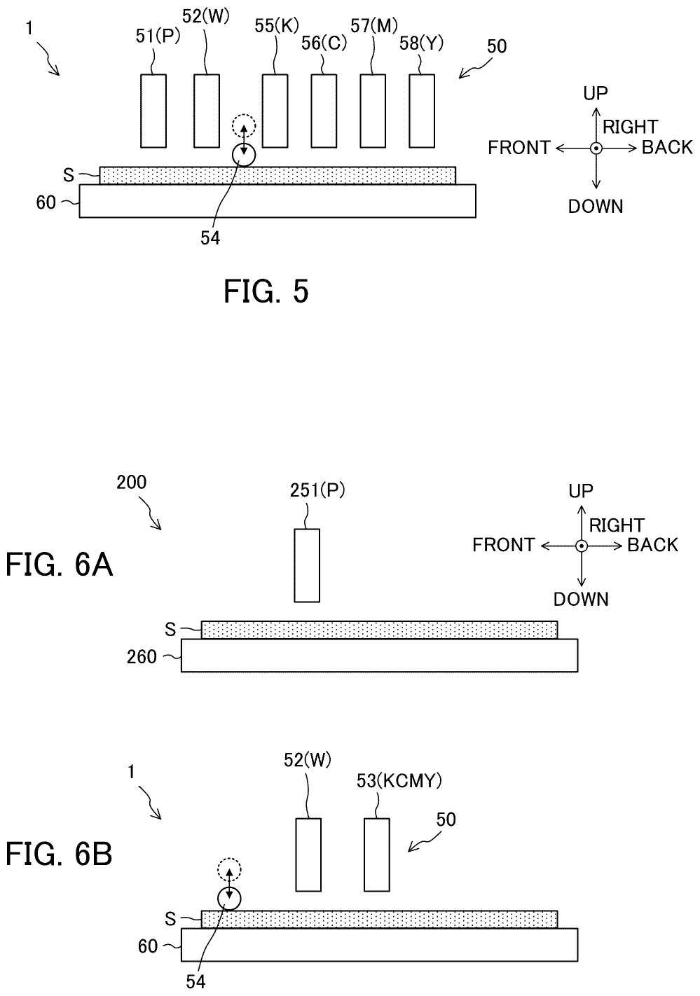

In the above description, the pretreatment liquid or the ink is discharged by a so-called serial method with each of the head 51 (P), the head 52 (W), and the head 53 (KCMY) illustrated in FIG. 2 moving in the width directions (left and right directions) of the base material S. However, a so-called line method in which the heads 51 to 53 are disposed over the entire width directions (left and right directions) of the base material S in the printing region may be adopted. In this case, as illustrated in FIG. 5 (first modification), instead of the head 53 (KCMY), a head 55 (K) that discharges a black ink, a head 56 (C) that discharges a cyan ink, a head 57 (M) that discharges magenta ink, and a head 58 (Y) that discharges a yellow ink are disposed for respective ink colors.

In the above description, the printing unit 50 of the textile printing apparatus 1 includes the head 51 (P) that discharges the pretreatment liquid. Alternatively, a pretreatment liquid application unit that applies the pretreatment liquid by a spray method, a roller method, or the like may be disposed. The head 51 (P) may be omitted, and the user may manually apply the pretreatment liquid using a spray, a roller, or the like. Alternatively, as illustrated in FIG. 6A corresponding to a second modification, a pretreatment liquid application device 200 including a head 251 (P) that discharges the pretreatment liquid may be disposed, and the head 251 (P) may discharge the pretreatment liquid onto the base material S on a stage 260. In this case, a system including the textile printing apparatus 1 in which the head 51 (P) is omitted as illustrated in FIG. 6B and the pretreatment liquid application device 200 illustrated in FIG. 6A can be regarded as a textile printing system. In the textile printing apparatus 1 illustrated in FIG. 6B, the roller 54 is positioned in front of the head 52. However, the positional relationship between the roller and the head may be changed freely.

### EXAMPLES

Hereinafter, the measurement of the film elongation of the resin contained in the base forming ink, the preparation of the pretreatment liquid and each ink, the details of each step, the evaluation of the textile printed material, and the results of Examples 1 to 3 and Comparative Example will be described.

### Measurement of Film Elongation

Regarding the resin contained in the base forming ink, an aqueous dispersion of each resin was applied onto a polytetrafluoroethylene sheet to obtain a film thickness of the resin after drying of 500 μm, dried at 23° C. for 15 hours, further dried at 80° C. for 6 hours and at 120° C. for 20 minutes, and then peeled from the sheet to prepare a resin film. This resin film was cut into a columnar shape having a width of 2 cm and a length of 4 cm to obtain a resin film test piece. Using a Tensilon universal testing machine RTC-1225A (manufactured by ORIENTEC CO., LTD.), the resin film test piece was stretched at a measurement temperature of 20° C. and a measurement speed of 200 mm/min, and the length of the resin film test piece that was stretched until the resin film test piece was broken was measured, and the ratio of the length to the original length was expressed as a percentage to obtain a film elongation.

### Preparation of Pretreatment Liquid (PT1)

A polyvalent metal salt “Calcium Chloride Dihydrate” (manufactured by FUJIFILM Wako Pure Chemical Corporation) in an amount of 33.1 g, 0.8 g of a nonionic surfactant “OLFIN E1010” (manufactured by Nissin Chemical Industry, Co., Ltd.), 15.5 g of a water-soluble solvent “Ethylene Glycol” (manufactured by FUJIFILM Wako Pure Chemical Corporation), 9.0 g of a water-soluble solvent “Glycerin” (manufactured by FUJIFILM Wako Pure Chemical Corporation), and 41.6 g of “ion-exchanged water” were mixed, and the mixture was filtered through a membrane filter having a pore size of 3 μm to obtain a pretreatment liquid PT1.

### Preparation of Base Forming Ink

(Preparation of White Pigment Dispersion)

Titanium oxide “R-62N” (manufactured by SAKAI CHEMICAL INDUSTRY CO., LTD.) in an amount of 300 g and 12 g of a pigment dispersant “DEMOL EP” (manufactured by Kao Corporation) (3.0 g as an active ingredient) were mixed with 688 g of “ion-exchanged water”, and the mixture was dispersed using a bead mill (manufactured by Shinmaru Enterprises Corporation, DYNO-MILL KDL Type A) at a filling ratio of 80% of 0.5 mmΦ zirconia beads and a retention time of 2 minutes to obtain a white pigment dispersion.

(Preparation of Base Forming Ink W1)

The “white pigment dispersion” in an amount of 150 g, 125 g (50 g as an active ingredient) of a resin emulsion “SUPERFLEX 740” (manufactured by DKS Co., Ltd., film elongation: 1300%), 100 g (30 g as an active ingredient) of a resin emulsion “SUPERFLEX 150” (manufactured by DKS Co., Ltd., film elongation: 330%), 25 g of a water-soluble solvent “Glycerin” (manufactured by FUJIFILM Wako Pure Chemical Corporation), 50 g of a water-soluble solvent “Diethylene Glycol” (manufactured by FUJIFILM Wako Pure Chemical Corporation), 2.5 g of a nonionic surfactant “OLFIN E1010” (manufactured by Nissin Chemical Industry, Co., Ltd.), and 47.5 g of “ion-exchanged water” were mixed, and the mixture was filtered through a membrane filter having a pore size of 3 μm to obtain a white base forming ink W1.

(Preparation of Base Forming Ink W2)

The “white pigment dispersion” in an amount of 150 g, 266.7 g (80 g as an active ingredient) of a resin emulsion “SUPERFLEX 150” (manufactured by DKS Co., Ltd., film elongation: 330%), 25 g of a water-soluble solvent “Glycerin” (manufactured by FUJIFILM Wako Pure Chemical Corporation), 50 g of a water-soluble solvent “Diethylene Glycol” (manufactured by FUJIFILM Wako Pure Chemical Corporation), 2.5 g of a nonionic surfactant “OLFIN E1010” (manufactured by Nissin Chemical Industry, Co., Ltd.), and 5.8 g of “ion-exchanged water” were mixed, and the mixture was filtered through a membrane filter having a pore size of 3 μm to obtain a white base forming ink W2.

### Preparation of Image Forming Ink M1

“CAB-O-JET260M” (manufactured by Cabot Corporation) in an amount of 35 g (pigment content: 3.5%), 33.3 g (15 g as an active ingredient) of a resin emulsion “Mowinyl 6817”, 10 g of a water-soluble solvent “Glycerin” (manufactured by FUJIFILM Wako Pure Chemical Corporation), 10 g of a water-soluble solvent “Diethylene Glycol” (manufactured by FUJIFILM Wako Pure Chemical Corporation), 0.5 g of a nonionic surfactant “OLFIN E1010” (manufactured by Nissin Chemical Industry, Co., Ltd.), and 11.2 g of “ion-exchanged water” were prepared, and the mixture was filtered through a membrane filter having a pore size of 3 μm to obtain a magenta image forming ink M1.

### Pretreatment Liquid Application Step

As the base material S, a black cotton T-shirt (product name: Printstar) manufactured by TOMS Co., Ltd. was used, and the pretreatment liquid was applied to a portion of 10 cm×20 cm on the surface of the black cotton T-shirt by an inkjet method. The image was a solid image, and the application amount of the pretreatment liquid was about 30 g/m². “MMP-8130” (trade name) manufactured by Mastermind Inc. was used as a printing apparatus for both the application of the pretreatment liquid and the application of the base forming ink and the image forming ink to be described later.

### Base Forming Ink Discharge Step

After the application of the pretreatment liquid, a white ink was applied to the portion to which the pretreatment liquid has been applied by an inkjet method without providing a drying step. The image was a solid image, and the application amount of the white ink was about 200 g/m².

### Leveling Step

After the application of the white ink, the base material S was pressurized using the roller 54 or an ironing surface of an iron (non-heated state) manually. As the iron, a steam iron manufactured by Panasonic Corporation was used. As the roller 54, a hard rubber roller having a width of 15 cm was used. The material of the component used for pressurizing the base material S is preferably a material to which the mixed liquid of the pretreatment liquid and the base forming ink is less likely to adhere. When a material to which the mixed solution is likely to adhere is used, a sheet such as a Teflon (registered trademark) sheet, a sheet to which the mixed solution is unlikely to adhere, or the like may be sandwiched between the pressurizing material and the base material S.

### Image Forming Ink Discharge Step

After the leveling step, the image forming ink M1 (magenta ink) was applied to the portion to which the white ink was applied by the inkjet method without providing a drying step. The image was a solid image, and the application amount of the image forming ink M1 was about 20 g/m². After the application of the magenta ink, the obtained material was heated and dried at 170° C. for 1 minute using a heat press machine manufactured by FUSION, and a textile printed material having a solid image of 10 cm×20 cm was obtained.

### Evaluation of Textile Printed Material

(Evaluation of Print Quality (White Dot))

The white dots in the solid image with the magenta ink of the textile printed material was visually evaluated and ranked according to the following criteria.

A: There are no white dots and no unevenness is felt.

B: There are few white dots, but no unevenness is felt.

C: There are many white dots, and unevenness is felt.

As the print quality, the color development of the solid image of the magenta ink of the textile printed material was visually evaluated, and the color development of the image was excellent in all of Examples 1 to 3 to be described later.

(Evaluation of Fastness to Rubbing (Fastness to Dry Rubbing))

Evaluation was performed using a Gakushin-type Rubbing Tester RT-200 (DAIEI KAGAKU SEIKI MFG. Co., Ltd.) based on the standard of JIS L 0849:2013. A white fabric cotton 100% canequim No. 3 for friction was attached to a friction block of the testing machine, and the friction block was placed on a printed portion without a weight and rubbed back and forth 100 times. After the rubbing, contamination of canequim No. 3 was graded on a gray scale and ranked according to the following criteria.

A: Grade 3.5 or higher

B: Grade 3.0 or higher and lower than grade 3.5

### Results of Examples 1 to 3 and Comparative Example

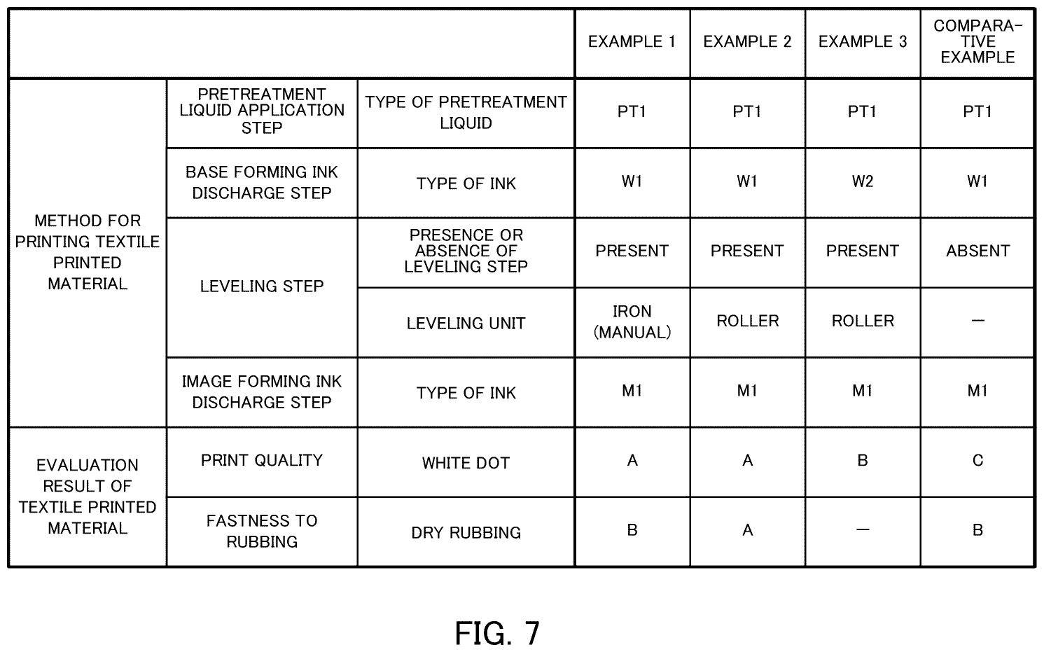

As shown in the table of FIG. 7, as the base forming ink, the base forming ink W1 was used in Examples 1, 2 and Comparative Example, and the base forming ink W2 was used in Example 3. Regarding the leveling step, a manual iron was used in Example 1, the roller 54 was used in Examples 2 and 3, and the leveling step was omitted in Comparative Example.

Examples 1 and 2 were evaluated as “A” for the white dots regarding the print quality and had very good print quality. Example 3, which is different from Example 2 (base forming ink W1) only in the base forming ink W2, was evaluated as “B” for the white dots regarding the print quality, but in Example 3, the white dots were few, and the print quality was good without unevenness. This result is considered to be because the base forming ink W1 of Example 2 containing a resin having a film elongation of 800% or more was leveled into a further flat layer in the leveling step as compared with the base forming ink W2 of Example 3.

On the other hand, Comparative Example, which is different from Examples 1 and 2 only in the presence or absence of the leveling step, was evaluated as “C” for the white dots regarding the print quality, having a print quality with many dots with unevenness. From the results, the effectiveness of the leveling step was confirmed.

Next, regarding the fastness to dry rubbing, Examples 1, 2 and Comparative Example were evaluated. Example 1 using a manual iron in the leveling step was evaluated “B”, and Example 2 using the roller 54 was evaluated as “A”. This result is considered to be because the base forming ink was able to be leveled by using the roller 54 rather than using a manual iron.

In the present embodiment described above, the textile printing apparatus 1 includes the head 52 (W), which is an example of the base forming ink head, the roller 54, which is an example of the leveler, and the head 53 (KCMY), which is an example of the image forming ink head. The head 52 (W) discharges a base forming ink onto the base material S to which a pretreatment liquid has been applied. The roller 54 levels the base forming ink discharged on the base material S. The head 53 (KCMY) discharges an image forming ink onto the base material S on which the base forming ink has been leveled.

In terms of the method, the method for producing a textile printed material includes applying a pretreatment liquid to the base material S (pretreatment liquid application step), discharging a base forming ink onto the base material S to which the pretreatment liquid has been applied (base forming ink discharge step), leveling the base forming ink discharged to the base material S (leveling step), and discharging an image forming ink onto the base material S on which the base forming ink has been leveled (image forming ink discharge step).

In the textile printing apparatus 1 and the method for producing a textile printed material, the base forming ink discharged on the base material S is leveled, and thus the image forming ink is discharged onto the flat base forming ink even when the base forming ink is discharged onto the base material S with the fluff of the base material S standing after the application of the pretreatment liquid. With this configuration, it is possible to avoid the problems that occur when the image forming ink is discharged onto the base material S in a state where the fluff of the base material S is standing unlike in the present embodiment, that is, problems such as occurrence of landing position shift of the image forming ink attached to the fluff due to falling down of the fluff in a drying treatment after image formation and generation of a dot-like stain of the color of the base forming ink in the image due to crushing of the base forming ink having a ball shape attached to the fluff. Thus, according to the present embodiment, the print quality can be improved in the textile printing apparatus 1 that discharges a base forming ink and an image forming ink and the method for producing a textile printed material.

In the textile printing apparatus 1 according to the present embodiment, the head 52 (W) discharges a base forming ink by a wet-on-wet method after application of the pretreatment liquid. In the method for producing a textile printed material according to the present embodiment, the base forming ink is discharged by a wet-on-wet method in (the step of) discharging the base forming ink onto the base material S to which the pretreatment liquid has been applied.

This makes it possible to improve productivity by omitting the time for the drying step as compared with the wet-on-dry method in which the drying step for the pretreatment liquid is performed after application of the pretreatment liquid and to avoid the problem that the drying of each of the heads 51 to 53 is promoted in the drying step and the nozzle is blocked in each of the heads 51 to 53. Further, the fluff of the base material S may still rise even after the drying step for the pretreatment liquid, but in the present embodiment, since the base forming ink is leveled after the discharge of the base forming ink, the above-described problems such as occurrence of landing position shift of the image forming ink and generation of a dot-like stain, which occur when the image forming ink is discharged onto the base material S in a state where the fluff of the base material S stands, can be avoided without passing through a drying step, as described above.

In the textile printing apparatus 1 according to the present embodiment, the head 52 (W) discharges a base forming ink containing a resin having a film elongation of 800% or more. In the method for producing a textile printed material according to the present embodiment, the base forming ink containing a resin having a film elongation of 800% or more is discharged in (the step of) discharging the base forming ink onto the base material S to which the pretreatment liquid has been applied.

The base forming ink increases its flexibility by containing a resin having a film elongation of 800% or more like this, which makes it easy to level the base forming ink when the base forming ink is leveled. As a result, it is possible to more reliably avoid the above-described problems such as occurrence of landing position shift of the image forming ink and generation of a dot-like stain, and thus, it is possible to further improve the print quality. When a large amount of resin having a film elongation of less than 800% is contained in the base forming ink, the viscosity of the base forming ink becomes too high, and thus discharge failure may occur, or the amount of pigment may be relatively reduced, leading to deterioration of image quality.

The present invention is not limited to the above-described embodiment as it is, and the constituent elements can be modified and embodied without departing from the gist thereof at the implementation stage. Various inventions can be formed by appropriately combining a plurality of constituent elements disclosed in the embodiment. For example, all the constituent elements shown in the embodiment may be appropriately combined. It is a matter of course that various modifications and applications can be made without departing from the gist of the invention. Hereinafter, the invention described in the claims as originally filed of the present application will be added.

According to an aspect, a textile printing apparatus includes:
a base forming ink head that discharges a base forming ink onto a base material to which a pretreatment liquid has been applied;
a leveler that levels the base forming ink discharged on the base material; and
an image forming ink head that discharges an image forming ink onto the base material on which the base forming ink has been leveled.

According to another aspect, the base forming ink head discharges the base forming ink by a wet-on-wet method after application of the pretreatment liquid.

According to another aspect, the base forming ink head discharges the base forming ink containing a resin having a film elongation of 800% or more.

According to another aspect, a method for producing a textile printed material, the method includes:
applying a pretreatment liquid to a base material;
discharging a base forming ink onto the base material to which the pretreatment liquid has been applied;
leveling the base forming ink discharged onto the base material; and
discharging an image forming ink onto the base material on which the base forming ink has been leveled.

What is claimed is:

1. A textile printing apparatus comprising:
a base forming ink head that discharges a base forming ink onto a base material to which a pretreatment liquid has been applied;
a leveler that levels the base forming ink discharged on the base material; and
an image forming ink head that discharges an image forming ink onto the base material on which the base forming ink has been leveled.

2. The textile printing apparatus according to claim 1, wherein
the base forming ink head discharges the base forming ink by a wet-on-wet method after application of the pretreatment liquid.

3. The textile printing apparatus according to claim 1, wherein
the base forming ink head discharges the base forming ink containing a resin having a film elongation of 800% or more.

4. A method for producing a textile printed material, the method comprising:
applying a pretreatment liquid to a base material;
discharging a base forming ink onto the base material to which the pretreatment liquid has been applied;
leveling the base forming ink discharged onto the base material; and
discharging an image forming ink onto the base material on which the base forming ink has been leveled.
